(19) United States
(12) Patent Application Publication
(10) Pub. No.: US 2023/0206687 A1
(43) Pub. Date: Jun. 29, 2023

(54) FACIAL IMAGE ACQUISITION SYSTEM, AND CONTROL METHOD AND CONTROL PROGRAM FOR FACIAL IMAGE ACQUISITION SYSTEM

(71) Applicant: OMRON CORPORATION, Kyoto-shi (JP)

(72) Inventors: Mamoru YABE, Kyoto-shi (JP); Junya FUJITA, Kyoto-shi (JP); Yoshinori ITO, Kyoto-shi (JP); Mitsunori SUGIURA, Kyoto-shi (JP)

(73) Assignee: OMRON CORPORATION, Kyoto-shi (JP)

(21) Appl. No.: 18/057,260

(22) Filed: Nov. 21, 2022

(30) Foreign Application Priority Data
Dec. 24, 2021 (JP) 2021-211427

(51) Int. Cl. G06V 40/16; G06V 40/20; G08B 21/18

(52) U.S. Cl. CPC G06V 40/172; H04N 23/56; G06V 40/20; G08B 21/182; G06V 40/166

(57) ABSTRACT

A facial image acquisition system 10 comprises a camera 11, a light guide plate 12, an LED 13, and a control device 20. The camera 11 is installed to photograph a person, and captures images over a specific capturing range. The light guide plate 12 is provided at a position adjacent to the capturing side of the camera 11, internally reflects light incident from a specific direction, emits the reflected light from a second surface 12c on the opposite side from a first surface 12b facing the camera 11 to perform the desired display, and is optically transmissive. The LED 13 irradiates the light guide plate 12 with light from a specific direction. The control device 20 controls the LED 13 so that light is emitted from the LED 13 according to information obtained by the camera 11.

### CROSS-REFERENCE TO RELATED APPLICATIONS

This application claims priority to Japanese Patent Application No. 2021-211427 filed on Dec. 24, 2021. The entire disclosure of Japanese Patent Application No. 2021-211427 is hereby incorporated herein by reference.

### BACKGROUND

### Technical Field

The present invention relates to a facial image acquisition system that makes use of a camera, and to a control method and a control program for a facial image acquisition system.

### Description of the Related Art

Recent years have seen the development of camera systems that perform facial recognition and attribute discrimination using surveillance cameras for crime prevention and digital marketing.

For example, Patent Literature 1 discloses a surveillance system in which a switch signal is inputted to a control device from a push-button switch when some kind of incident occurs, and sound, light, or the like is generated from an induction signal generator installed near a surveillance camera, in order to allow a person's face to be photographed from the front so as to improve the accuracy of facial recognition and attribute discrimination.

### CITATION LIST

### Patent Literature

Patent Literature 1: JP-A H7-38786

Patent Literature 2: JP-A 2011-195227

### SUMMARY

### Problem to be Solved by the Invention

However, the following problem is encountered with the above conventional monitoring systems.

That is, with the monitoring systems disclosed in the above publications, in order to photograph a person's face from the front, the configuration is such that sound and light are emit from the direction of the monitoring camera so that the person's face is turned toward the camera, so there is a risk that this will make the person feel uncomfortable.

It is an object of the present invention to provide a facial image acquisition system, and a control method and a control program for this facial image acquisition system, with which the accuracy of facial recognition and attribute discrimination of a person can be improved without making the person feel uncomfortable.

### Means for Solving Problem

The facial image acquisition system according to the first invention comprises a camera, a light guide plate, a first light source unit, and a control unit. The camera is installed to photograph people, and photographs within a specific capturing range. The light guide plate is provided at a position adjacent to the capturing side of the camera, internally reflects light incident from a specific direction and emits the light from a second surface on the opposite side from a first surface facing the camera, performs the desired display, and is optically transmissive. The first light source unit causes light to be incident on the light guide plate from a specific direction. The control unit controls the first light source unit to emit light according to information obtained by the camera.

Here, a light guide plate (STP) is installed at a position adjacent to the capturing side (lens side) of the camera, and the first light source unit is controlled so that light from the first light source unit irradiates the light guide plate according to camera video, etc.

Here, the camera includes, for example, any of various cameras installed for crime prevention, monitoring, watching over, or marketing. The information obtained by the camera includes, for example, behavioral information about people acting suspiciously, elderly people who are wandering around, people stopping in front of specific products in department stores, and so on.

For example, the light guide plate internally reflects light incident from an incident surface such as an end surface, and emits the light from an emission surface, thereby providing a specific display (such as advertisements or information of interest) when viewed from the emission surface side. Also, since the light guide plate is optically transmissive, a camera disposed adjacent to the first surface side is visible when viewed from the second surface side in a state in which no light is incident.

The first light source unit is, for example, an LED (light emitting diode), and irradiates the incident surface of the light guide plate with light.

For example, the control unit controls the first light source unit so that light from the first light source unit is repeatedly switched on and off according to information captured by the camera.

Consequently, by controlling the first light source unit and performing the desired display on the light guide plate for a person who is in the capturing range of the camera, it is possible to catch the attention of a subject (such as a suspicious person, a person to be watched over, a person to whom marketing is aimed, etc.) and induce that person to turn around in the direction of the light guide plate.

Therefore, the camera disposed adjacent to the first surface side of the light guide plate can photograph the face of the subject substantially from the front, which means that an appropriate facial image for use in facial recognition or attribute discrimination can be acquired, for example.

Furthermore, it is difficult for a subject who is looking at the light guide plate to see the camera disposed adjacent to the rear surface (first surface) side of the light guide plate in a state in which a specific display is being displayed on the light guide plate.

As a result, the accuracy of facial recognition and attribute discrimination of a person can be improved without making that person feel uncomfortable.

The facial image acquisition system according to the second invention is the facial image acquisition system according to the first invention, wherein, when the light emitted from the first light source unit is incident on the light guide plate, the light guide plate displays a pattern that attracts people's attention when viewed from the second surface.

Consequently, a subject (such as a suspicious person, a person to be watched over, a person to whom marketing is aimed, etc.) can be effectively induced to turn in the direction of the light guide plate when the attention of that person is caught by the display on the light guide plate of a pattern that catches the attention of the person.

The facial image acquisition system according to the third invention is the facial image acquisition system according to the first or second invention, wherein, when the light emitted from the first light source unit is incident on the light guide plate, the light guide plate performs display such that the camera becomes invisible when viewed from the second surface.

Consequently, for example, even when a subject, such as a suspicious person or an elderly person who is to be watched over, looks in the direction of the light guide plate, the camera disposed adjacent to the rear surface side of the light guide plate cannot be visually recognized, which means that the subject will not notice the camera and feel uncomfortable.

The facial image acquisition system according to the fourth invention is the facial image acquisition system according to any of the first to third inventions, wherein the light guide plate makes the camera visible when viewed from the second surface in a state in which the light emitted from the first light source unit is not incident.

Consequently, if no light is incident from the first light source unit, the presence of the camera disposed on the rear surface side (first surface) can be visually recognized through the light guide plate. Therefore, since the camera can be seen in a state in which no specific display is being made on the light guide plate, installing the camera provides a crime deterrent effect.

The facial image acquisition system according to the fifth invention is the facial image acquisition system according to any of the first to third inventions, further comprising a smoked plate that is provided between the light guide plate and the camera, and that makes the camera invisible when viewed from the second surface side of the light guide plate.

Consequently, regardless of whether or not there is a display on the light guide plate (whether the first light source unit is switched on or off), the smoked plate is provided so that the camera cannot be seen, so a subject photographed by the camera will not feel uncomfortable.

The facial image acquisition system according to the sixth invention is the facial image acquisition system according to any of the first to fifth inventions, wherein the control unit has a first mode for switching off the first light source unit and a second mode for switching on the first light source unit.

Consequently, a specific display on the light guide plate can be toggled on and off by switching between the first mode and the second mode according to the information acquired from the camera, while the light from the first light source unit is turned on and off.

The facial image acquisition system according to the seventh invention is the facial image acquisition system according to the sixth invention, wherein, if the image obtained from the camera includes a person who seems to be a specific subject, the control unit irradiates the light guide plate with light from the first light source unit in the second mode.

Consequently, for example, when a subject registered as a suspicious person, an elderly person who may be lost, a subject to whom marketing is aimed, etc., is included in the camera image, a specific display is performed on the light guide plate in the second mode, which causes the subject to turn his or her face toward the light guide plate, and allows a facial image to be obtained substantially from the front.

The facial image acquisition system according to the eighth invention is the facial image acquisition system according to any of the first to seventh inventions, further comprising a human behavior monitoring unit that monitors the behavior of people within the capturing range of the camera and determines whether or not a person is a monitoring target.

Consequently, for example, by monitoring the behavior of a suspicious person, such as a person who is going back and forth to and from the same place, if the person is determined to be a person to be monitored, a facial image can be acquired in a state in which a specific display is performed on the light guide plate for that subject.

The facial image acquisition system according to the ninth invention is the facial image acquisition system according to any of the first to eighth inventions, wherein the control unit controls the first light source unit so as to perform a specific display according to the attributes of a person looking in the direction of the camera.

Consequently, for example, when a light guide plate is installed as a display for a specific product in a department store, etc., effective displays of advertisements and so forth can be performed to match the attributes of a person who stops because he or she is interested in the specific product.

The facial image acquisition system according to the tenth invention is the facial image acquisition system according to the ninth invention, wherein the specific display includes advertisements and information of interest to that person.

Consequently, for example, when a light guide plate is installed as a display for a specific product in a department store, etc., a more effective advertising effect can be obtained by having the light guide plate display advertisements and information that catch the interest of a person who stops because he or she is interested in the specific product.

The facial image acquisition system according to the eleventh invention is the facial image acquisition system according to any of the first to tenth inventions, wherein the control unit controls the emission of light from the first light source unit by time division.

Consequently, the first light source unit is controlled to irradiate the light guide plate by time division for a person who is in the capturing range of the camera, and an image is acquired at a point when no light is being emitted from the first light source unit, for example, which allows a clearer image to be acquired by the camera without being affected by the light from the first light source unit.

The facial image acquisition system according to the twelfth invention is the facial image acquisition system according to any of the first to eleventh inventions, further comprising a second light source unit that is disposed on the first surface side of the light guide plate and emits a flash that causes the person to turn around.

Consequently, since the second light source unit that emits a flash of light is provided on the first surface side of the light guide plate adjacent to the camera, in addition to the display on the light guide plate, the stimulation by the flash of light causes a person who is in the capturing range to turn around in the direction of the light guide plate.

Also, since the second light source unit is also disposed on the rear surface (first surface) side of the light guide plate, as is the camera, even if the subject turns toward the light guide plate, that person will not feel uncomfortable.

The facial image acquisition system according to the thirteenth invention is the facial image acquisition system according to any of the first to twelfth inventions, wherein the lens of the camera is disposed so as to be adjacent to an area provided on the first surface of the light guide plate and in which no light-reflecting microprisms are disposed.

Consequently, a clear facial image can be acquired by the camera, without being affected by the microprisms.

The facial image acquisition system according to the fourteenth invention is the facial image acquisition system according to any of the first to thirteenth inventions, wherein the control unit performs control so as to switch the direction in which light is incident on the light guide plate, and switch the plurality of patterns displayed on the light guide plate.

Consequently, when a specific display is displayed on the light guide plate and the subject is made to turn around, if the display is switched to a more interesting pattern that will catch the subject's interest better, the subject can be induced to gaze in the direction of the light guide plate, which allows the camera to acquire a facial image of a subject more effectively.

The facial image acquisition system pertaining to the fifteenth invention is the facial image acquisition system pertaining to the fourteenth invention, wherein microprisms corresponding to a plurality of patterns are disposed in a plurality of patterns inside the light guide plate, in a state in which a person's face can be recognized through the light guide plate from the camera.

Consequently, a state in which the camera can recognize the face of the subject through the light guide plate can be ensured, and since the microprisms are provided in a plurality of patterns, it is possible to switch among a plurality of displays on the light guide plate.

The facial image acquisition system according to the sixteenth invention is the facial image acquisition system according to any of the first to fifteenth inventions, further comprising a sound information output unit that outputs sound information that matches what is displayed on the light guide plate.

Consequently, in addition to the display on the light guide plate, a person who is within the capturing range can be induced to turn in the direction of the light guide plate by the stimulation provided by the sound information.

The facial image acquisition system according to the seventeenth invention is the facial image acquisition system according to any of the first to sixteenth inventions, further comprising a facial recognition possibility determination unit that determines whether or not the facial recognition of the person photographed by the camera is at or above a specific determination value.

Consequently, it is determined whether or not a facial image acquired by the above-mentioned facial image acquisition system is suitable for facial recognition, which allows a facial image suitable for facial recognition to be obtained more reliably by performing control, such as switching the display on the light guide plate, until a facial image that can be used for facial recognition is obtained, for example.

The facial image acquisition system according to the eighteenth invention is the facial image acquisition system according to the seventeenth invention, wherein the control unit counts the number of times that the determination result from the facial recognition possibility determination unit is negative, and controls the first light guide plate so that the display of the light guide plate is switched until the count exceeds a specific number of times.

Consequently, the system can attempt to acquire a favorable facial image of the subject by repeatedly switching the display on the light guide plate up until the number of times that the result of determining whether or not a facial image acquired by the above-mentioned facial image acquisition system is an image suitable for facial recognition becomes negative has exceeded a specific number of times.

The facial image acquisition system according to the nineteenth invention is the facial image acquisition system according to the eighteenth invention, further comprising a storage unit that stores facial images of specific person in advance, and a person comparison unit that compares the facial image of a person photographed by the camera with the facial images of the specific person stored in the storage unit when the determination result of the facial recognition possibility determination unit is at or above the determination value.

Consequently, by comparing the facial images stored in the storage unit with a facial image acquired by the facial image acquisition system, it can be determined, for example, whether or not there is a match with the face of a subject registered as a suspicious person, or of an elderly person who may be lost.

The facial image acquisition system according to the twentieth invention is the facial image acquisition system according to the nineteenth invention, further comprising an alert unit that issues an alert when it is determined that the facial image of the person photographed by the camera matches the facial image of a specific person stored in advance, as a result of comparison by the person comparison unit.

Consequently, when the result of determination by the person comparison unit is a match to a specific person, an appropriate response can be made by issuing an alert, such as informing the manager of the facility.

The method for controlling a facial image acquisition system according to the twenty-first invention is a method for controlling the facial image acquisition system according to any of the first to twentieth inventions, the control method comprising an image acquisition step and a display step. The image acquisition step involves acquiring an image of the specific capturing range photographed by the camera. The display step involves performing the desired display as viewed from the second surface side of the light guide plate by emitting light from the first light source unit according to information about the image acquired in the image acquisition step.

Here, a light guide plate (STP) is installed at a position adjacent to the capturing side (lens side) of the camera, and the first light source unit is controlled so as to irradiate the light guide plate with light from the first light source unit according to video from the camera, etc.

Here, the camera includes, for example, any of various cameras installed for crime prevention, monitoring, watching over, or marketing. The information obtained by the camera includes, for example, behavioral information about people acting suspiciously, elderly people who are wandering around, people stopping in front of specific products in department stores, and so on.

For example, the light guide plate internally reflects light incident from an incident surface such as an end surface, and emits the light from an emission surface, thereby providing a specific display (such as advertisements or information of interest) when viewed from the emission surface side. Also, since the light guide plate is optically transmissive, a camera disposed adjacent to the first surface side is visible when viewed from the second surface side in a state in which no light is incident.

The first light source unit is, for example, an LED (light emitting diode), and irradiates the incident surface of the light guide plate with light.

For example, the control unit controls the first light source unit so that light from the first light source unit is repeatedly switched on and off according to information captured by the camera.

Consequently, by controlling the first light source unit and performing the desired display on the light guide plate for a person who is in the capturing range of the camera, it is possible to catch the attention of a subject (such as a suspicious person, a person to be watched over, a person to whom marketing is aimed, etc.) and induce that person to turn around in the direction of the light guide plate.

Therefore, a camera disposed adjacent to the first surface side of the light guide plate can photograph the face of the subject substantially from the front, which means that an appropriate facial image for use in facial recognition or attribute discrimination can be acquired, for example.

Furthermore, it is difficult for a subject who is looking at the light guide plate to see the camera disposed adjacent to the rear surface (first surface) side of the light guide plate in a state in which a specific display is being displayed on the light guide plate.

As a result, the accuracy of facial recognition and attribute discrimination of a person can be improved without making that person feel uncomfortable.

The program for controlling a facial image acquisition system according to the twenty-second invention is a program for controlling the facial image acquisition system according to any of the first to twentieth inventions, which causes a computer to execute a facial image acquisition system control method comprising an image acquisition step and a display step. The image acquisition step involves acquiring an image of the specific capturing range photographed by the camera. The display step involves performing the desired display as viewed from the second surface side of the light guide plate by emitting light from the first light source unit according to information about the image acquired in the image acquisition step.

Here, a light guide plate (STP) is installed at a position adjacent to the capturing side (lens side) of the camera, and the first light source unit is controlled so as to irradiate the light guide plate with light from the first light source unit according to video from the camera, etc.

Here, the camera includes, for example, any of various cameras installed for crime prevention, monitoring, watching over, or marketing. The information obtained by the camera includes, for example, behavioral information about people acting suspiciously, elderly people who are wandering around, people stopping in front of specific products in department stores, and so on.

For example, the light guide plate internally reflects light incident from an incident surface such as an end surface, and emits the light from an emission surface, thereby providing a specific display (such as advertisements or information of interest) when viewed from the emission surface side. Also, since the light guide plate is optically transmissive, a camera disposed adjacent to the first surface side is visible when viewed from the second surface side in a state in which no light is incident.

The first light source unit is, for example, an LED (light emitting diode), and irradiates the incident surface of the light guide plate with light.

For example, the control unit controls the first light source unit so that light from the first light source unit is repeatedly switched on and off according to information captured by the camera.

Consequently, by controlling the first light source unit and performing the desired display on the light guide plate for a person who is in the capturing range of the camera, it is possible to catch the attention of a subject (such as a suspicious person, a person to be watched over, a person to whom marketing is aimed, etc.) and induce that person to turn around in the direction of the light guide plate.

Therefore, a camera disposed adjacent to the first surface side of the light guide plate can photograph the face of the subject substantially from the front, which means that an appropriate facial image for use in facial recognition or attribute discrimination can be acquired, for example.

Furthermore, it is difficult for a subject who is looking at the light guide plate to see the camera disposed adjacent to the rear surface (first surface) side of the light guide plate in a state in which a specific display is being displayed on the light guide plate.

As a result, the accuracy of facial recognition and attribute discrimination of a person can be improved without making that person feel uncomfortable.

### Effects

With the facial image acquisition system of the present invention, the accuracy of facial recognition and attribute discrimination of a person without making that person feel uncomfortable.

### BRIEF DESCRIPTION OF THE DRAWINGS

FIG. 1 is a system configuration diagram showing the configuration of a facial image acquisition system according to an embodiment of the present invention;

FIG. 2 is a concept diagram showing a layout example of the camera, light guide plate, LED, control device, and so forth included in the facial image acquisition system in FIG. 1;

FIG. 3 is a detail concept diagram showing the components around the LED and the light guide plate included in the facial image acquisition system in FIG. 1;

FIG. 4 is a control block diagram of the facial image acquisition system in FIG. 1;

FIG. 5 is a graph of pulse signals transmitted by time-division control to the LED in the facial image acquisition system of FIG. 1;

FIG. 6 is a schematic diagram showing a normal state in the facial image acquisition system of FIG. 2;

FIG. 7 is a schematic diagram showing an alert state in the facial image acquisition system of FIG. 2;

FIG. 8 is a flowchart of the flow of processing in a method for controlling the facial image acquisition system of FIG. 1;

FIG. 9 is a flowchart of the flow of processing in a method for controlling the facial image acquisition system of FIG. 1;

FIG. 10 is a concept diagram showing a layout example of the camera, light guide plate, LED, flash light, speaker, control device, and so forth included in the facial image acquisition system according to another embodiment of the present invention;

FIG. 11 is a concept diagram showing a layout example of the camera, light guide plate, LED, smoked panel, control device, and so forth included in the facial image acquisition system according to yet another embodiment of the present invention; and

FIG. 12 is a concept diagram showing a layout example of the camera, light guide plate, LED, control device, and so forth included in the facial image acquisition system according to still another embodiment of the present invention.

### DETAILED DESCRIPTION OF THE EMBODIMENT

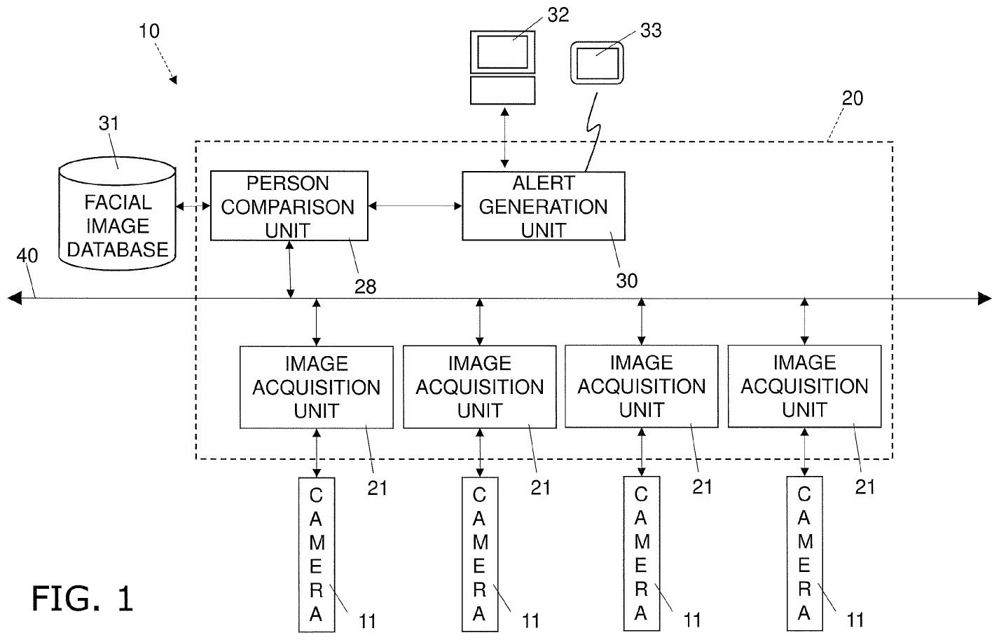

The facial image acquisition system according to an embodiment of the present invention will now be described with reference to FIGS. 1 to 9.

In this embodiment, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand the present invention, but does not intend for these to limit what is discussed in the patent claims.

### (1) Configuration of Facial Image Acquisition System 10

The facial image acquisition system 10 according to this embodiment is, for example, a system for acquiring facial images, including the faces of people in a store, facility, shopping district, etc., by using a plurality of cameras or the like that are installed in a store for monitoring an unspecified large number of people, and as shown in FIG. 1, comprises a plurality of cameras 11 installed in a store or the like, a control device (control unit) 20, a facial image database (storage unit) 31, a manager terminal 32, a terminal device 33, and a management information bus 40.

The cameras 11 are installed in areas where monitoring, watching, and so forth are performed in shops, facilities, and the like, and the images (video) captured by the cameras 11 are acquired by image acquisition units 21 inside the control device 20 as shown in FIG. 1.

As shown in FIG. 1, the control device 20 comprises at least the image acquisition units 21 corresponding to the plurality of cameras 11, a person comparison unit 28, and an alert generation unit 30.

The image acquisition units 21 acquire images (video) captured by the cameras 11 and transmit these to the person comparison unit 28 via a management information bus 40. The image acquisition units 21 also acquires, from among the continuously captured images, only those images captured when the LED (light emitting diode) (first light source unit) 13 was off, at the point when the LED, which is controlled by the light source control unit 26 (discussed below) in time division to repeatedly switch on and off, has switched off.

The person comparison unit 28 receives images captured by the cameras 11, via the image acquisition unit 21, and compares these images with the facial image of a specific subject stored in the facial image database 31 to determine whether or not there is a match. This makes it easy to determine whether or not there is a match by comparing the images captured by the cameras 11 installed in a facility or the like with the facial image of a specific person registered in advance in the facial image database 31.

The alert generation unit 30 is connected to the person comparison unit 28, as shown in FIG. 1. In the event that the result of comparison by the person comparison unit 28 reveals, for example, a person registered as a suspicious person, an elderly person registered as likely to become lost, or a suspicious person who does not match a registered person such as a staff member or a resident of a senior facility or the like, the alert generation unit 30 transmits an alert that a suspicious person or the like has been found, to the manager terminal 32, a terminal device 33 owned by the staff of the facility, or the like.

FIG. 1 shows only the main components of the control device 20, and the detailed configuration of the control device 20 will be described below.

As shown in FIG. 1, the facial image database 31 is connected to the person comparison unit 28, and stores facial images of pre-registered subjects (suspicious persons to be monitored, elderly persons to be watched over, residents and staff members a of facility, etc.).

In particular, with the facial image acquisition system 10 of this embodiment, a large number of facial images of persons to be monitored, etc., are required in order to compare with the large number of images captured by the cameras 11 installed in a shop, a facility, or the like, and therefore the facial image database 31 holds a large quantity of facial image data for persons to be monitored, etc.

The manager terminal 32 is a PC (personal computer) used by the manager of the facility, is connected to the alert generation unit 30 as shown in FIG. 1, and receives an alert signal from the alert generation unit 30.

The terminal device 33 is a portable terminal used by staff members of the facility, etc., is connected to the alert generation unit 30 as shown in FIG. 1, receives an alert signal from the alert generation unit 30.

Consequently, when a suspicious person or an elderly person or other person to be watched over is detected from an image of a camera 11, an alert signal is transmitted to the manager terminal 32 or the terminal device 33, which allows a manager, a staff member, or the like to take prompt and appropriate action.

Next, the configuration around each of the cameras 11 installed in a facility or the like will be described.

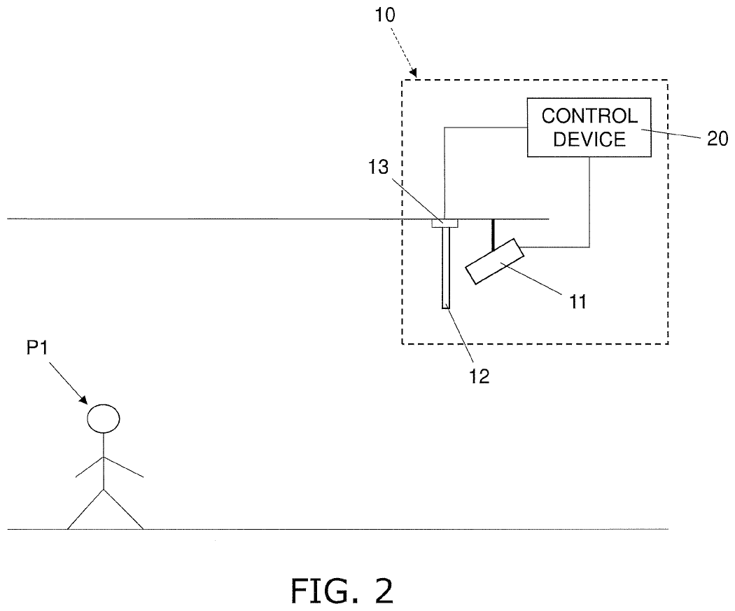

The facial image acquisition system 10 of this embodiment comprises a camera 11, a light guide plate 12, an LED (light source unit) 13, and a control device 20, as shown in FIG. 2.

The camera 11 is an imaging device that captures an image of a person P1 within a capturing range, and as a general rule is always capturing images within the imaging space. As shown in FIG. 2, the camera 11 is installed on the ceiling of a facility or the like, and is disposed at a position adjacent to the rear surface (first surface) side of the light guide plate 12.

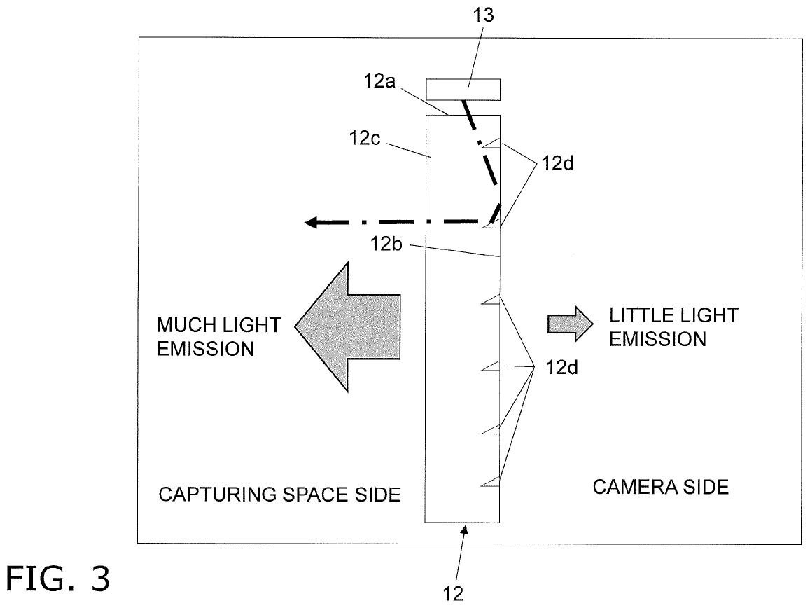

As shown in FIG. 2, the light guide plate 12 is disposed adjacent to the capturing side (lens side) of the camera 11, and when the light emitted from the LED 13 is incident, the light is reflected by microprisms 12d (see FIG. 3) and exits from a second surface 12c, and a pattern or the like is displayed according to the pattern of the microprisms 12d.

More precisely, as shown in FIG. 3, the light guide plate 12 has an end surface (incident surface) 12a on which the light emitted from the LED 13 is incident, a first surface (reflection surface) 12b, a second surface (emission surface) 12c, and microprisms 12d.

As shown in FIG. 3, the end surface 12a is disposed at a position opposite the LED 13, and the light emitted from the LED 13 is incident thereon.

As shown in FIG. 2, the first surface 12b is the surface of the light guide plate 12 that is adjacent to the camera 11, and as shown in FIG. 3, the microprisms 12d are formed in a specific pattern on the inner surface side.

As shown in FIG. 3, the second surface 12c is an emission surface on the opposite side from the first surface 12b, and is disposed on the imaging subject side of the camera 11.

As shown in FIG. 3, the microprism 12d are formed on the inner surface side of the first surface 12b, and have a substantially triangular shape when viewed in cross section. Also, the microprisms 12d are formed in a specific arrangement to match the pattern displayed on the light guide plate 12.

Consequently, the light emitted from the LED 13 and incident from the end surface 12a is reflected by the microprisms 12d formed in a specific pattern, and is emitted from the second surface (emission surface) 12c, which allows a pattern or the like to be displayed as viewed from the second surface 12c side.

Here, when the light emitted from the LED 13 is incident on the light guide plate 12 and a pattern or the like is displayed on the light guide plate 12, the camera 11 disposed on the rear surface side becomes invisible through the light guide plate 12.

As a result, a person who looks at the light guide plate 12 on which the pattern or the like is displayed will not notice the presence of the camera 11 on the rear surface side thereof, so that person will not feel uncomfortable.

On the other hand, in a state in which no light is being emitted from the LED 13, no pattern or the like is displayed on the light guide plate 12, and the camera 11 disposed on the rear surface side can be seen through the light guide plate 12, which is optically transmissive.

Consequently, when the LED 13 is switched off, the camera 11 on the rear surface side the light guide plate 12 can be seen through the light guide plate 12, and being able to see the camera 11 provides a crime deterrent effect.

As shown in FIGS. 2 and 3, the LED 13 is disposed at a position opposite the upper end surface 12a of the light guide plate 12, and irradiates the end surface 12a with light. The light emitted from the LED 13 is reflected by the microprisms 12d formed on the inner surface side of the first surface 12b, as indicated by the one-dot chain line in FIG. 3, and is emitted from the second surface 12c side toward the imaging space.

Here, most of the light emitted from the LED 13 is emitted from the second surface 12c side as shown in FIG. 3, but part of this light is emitted from the first surface 12b side. Even a small amount of light emitted from the first surface 12b side may diminish the quality of the image captured by the camera 11 disposed at a position adjacent to the first surface 12b.

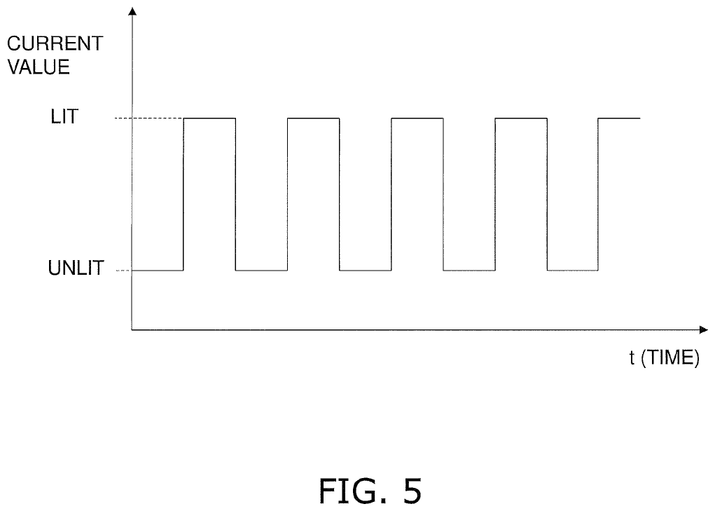

For this reason, with the facial image acquisition system 10 of this embodiment, a specific pulse signal (see FIG. 5) is transmitted to the LED 13 to control the LED 13 so that its lighting is controlled by time division, in which the LED 13 is repeatedly turned on and off for a specific length of time. The image acquisition unit 21 then acquires from the camera 11 an image captured at the point when the LED 13 was switched off, which allows a high-definition image to be acquired without being adversely affected by the small amount of light coming from the first surface 12b.

Next, the detailed configuration of the control device 20 will be described.

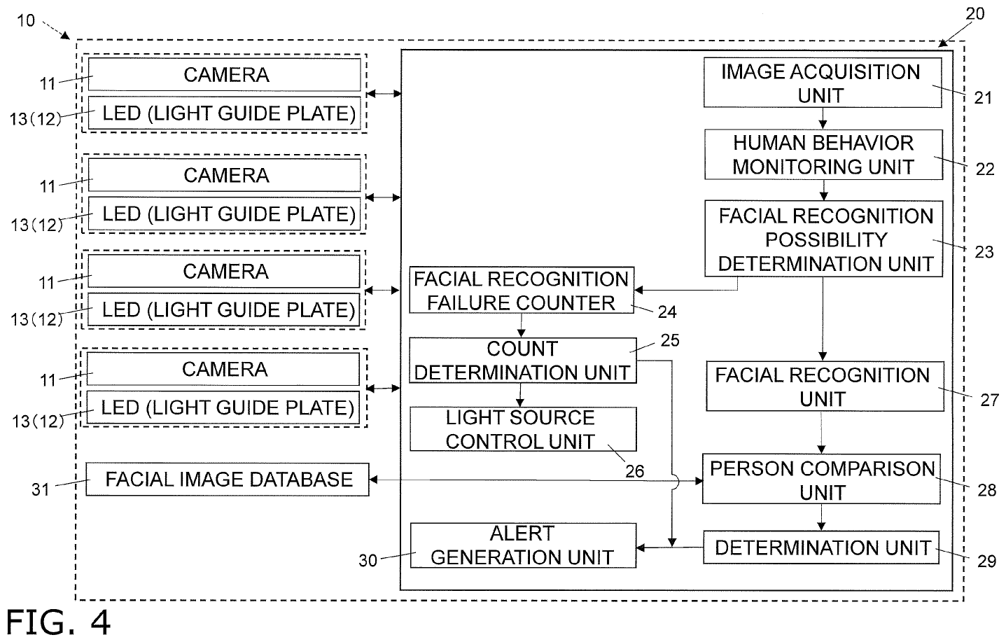

As shown in FIG. 4, the control device 20 comprises image acquisition units 21, human behavior monitoring unit 22, a facial recognition possibility determination unit 23, a facial recognition failure counter 24, a count determination unit 25, a light source control unit 26, a facial recognition unit 27, a person comparison unit 28, a determination unit 29, and the alert generation unit 30.

The image acquisition units 21 are provided corresponding to the plurality of cameras 11, as shown in FIG. 1.

In this embodiment, as described above, an image acquisition unit 21 synchronizes with an LED 13 that is repeatedly switched on and off by the pulse signals shown in FIG. 5, so that images captured by the camera 11 when the LED is turned off are acquired as facial images for facial recognition.

Consequently, as shown in FIG. 3, when an LED 13 is turned on, a high-definition image can be captured by the camera 11, without being affected by light leaking out toward the first surface 12b of the light guide plate 12.

As shown in FIG. 4, the human behavior monitoring unit 22 is connected to the image acquisition unit 21, and the images acquired from the image acquisition unit 21 are used to monitor the behavior of the person being photographed. More specifically, the human behavior monitoring unit 22 acquires video or the like captured by the camera 11, and monitors whether or not the person included in the video is moving suspiciously.

More specifically, the human behavior monitoring unit 22 detects and monitors, as a person with suspicious movements, a person moving back and forth within the capturing range of the camera 11, a person hanging around, etc. For example, the number of times that a specific person moves back and forth within a specific capturing range in a specific length of time is counted, and if the count reaches a preset number, the human behavior monitoring unit 22 determines that person to be someone with suspicious behavior.

The facial recognition possibility determination unit 23 acquires an image including the face of a person who has been determined to be acting suspiciously by the human behavior monitoring unit 22, and determines whether or not that image is one with which facial recognition can be performed. More specifically, the facial recognition possibility determination unit 23 determines whether or not facial recognition is possible according to whether or not the orientation of the face of the person included in the image, the brightness of the image, and so forth satisfy specific criteria.

The facial recognition failure counter 24 counts the number of times that the facial recognition possibility determination unit 23 has determined that facial recognition is impossible because the face orientation and other such conditions are not satisfied in facial recognition possibility determination of the same person.

The count determination unit 25 determines whether the count taken by the facial recognition failure counter 24 is less than a specific set number of times or is equal to or greater than a specific number of times.

For example, if the count is less than the set number of times, that count is transmitted to the light source control unit 26. On the other hand, if the count is greater than or equal to the set number of times, an alert signal is transmitted to the alert generation unit 30.

The light source control unit 26 receives the count value transmitted from the count determination unit 25 when the count is less than the set number of times, and performs lighting control over the LED 13 according to the count value.

For example, if the set number of times is 4 and the count value is 1 time, the light source control unit 26 performs control to light the LED 13. Also, if the count value is 2 times, the light source control unit 26 performs control to cause the LED 13 to blink at intervals that can be recognized by the human eye. Furthermore, if the count value is 3 times, the light source control unit 26 performs control to light the LED 13 more brightly by increasing the current flowing to the LED 13.

Consequently, the light emitted from the LED 13 is incident from the end surface 12a of the light guide plate 12, is reflected by the microprisms 12d, and is emitted from the second surface 12c, which allows a specific pattern or the like to be displayed according to the lighting control of the LED 13.

A subject who is within the capturing range of the camera 11 (in particular, a person who has been determined to be a suspicious person) will be distracted by the display on the light guide plate 12 produced by the lighting control of the LED 13. The subject will therefore turn in the direction of the light guide plate 12, so the camera 11 can acquire a good facial image, in which the subject is facing toward the camera 11 on the rear side through the light guide plate 12.

If the facial recognition possibility determination unit 23 determines that facial recognition is possible, the facial recognition unit 27 uses the facial image to perform facial recognition so as to calculate the quantitative features of the face.

The person comparison unit 28 uses the quantitative features of the face calculated by the facial recognition unit 27 to determine whether or not the face of the subject included in the image matches the face of a person registered in advance in the facial image database 31.

Here, the facial image database 31 holds facial image data for people requiring attention, suspicious people, etc., for the purpose of comparison with the face of a person included in the image captured by the camera 11 in real time. Therefore, the person comparison unit 28 can compare the facial images stored in the facial image database 31 for each facial image for which facial recognition has been performed.

As a result of the comparison performed by the person comparison unit 28, the determination unit 29 determines whether or not the features of the subject's face captured by the camera 11 match the features of the facial images stored in advance in the facial image database 31 as a person requiring attention, a suspicious person, or the like. Here, if the degree of matching between the two is high, an alert signal is transmitted to the alert generation unit 30.

As a result of the determination made by the determination unit 29, if it is determined that the features of the subject's face captured by the camera 11 have a high degree of matching with the features of a facial image stored in the facial image database 31, the alert generation unit 30 transmits an alert signal to the manager terminal 32 and the terminal device 33 (see FIG. 1).

As a result, the manager or a staff member of the facility where the camera 11 is installed recognizes from the alert signal received from the alert generation unit 30 that there is a person requiring attention in the facility, and can take appropriate measures.

### Pattern Display Control on Light Guide Plate 12

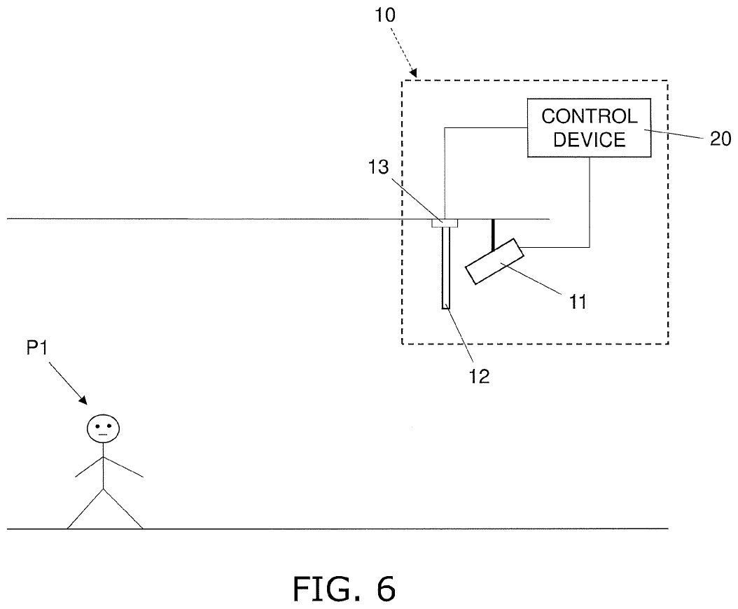

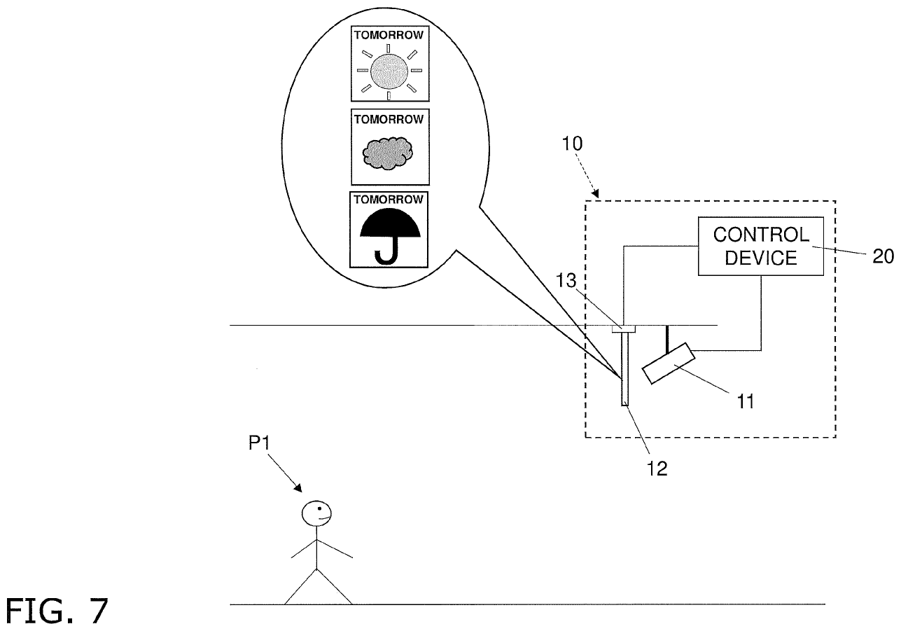

Display control for attracting the attention of a person who is within the capturing range of the camera 11 by displaying a pattern or the like on the light guide plate 12 with the facial image acquisition system 10 of this embodiment will be described below with reference to FIGS. 6 and 7.

FIG. 6 shows the state of the control device 20 in normal mode (first mode).

In normal mode, the human behavior monitoring unit 22 of the control device 20 shown in FIG. 6 monitors the behavior of a person P1 who is within the capturing range of the camera 11, and monitors whether the person is a suspicious person or the like.

At this point, the control device 20 puts the LED 13 in an off state in which no light is emitted, and no pattern or the like is displayed on the light guide plate 12. Consequently, since the light guide plate 12 is substantially transparent when viewed by the person P1 in the capturing range, the camera 11 disposed adjacent to the rear surface side of the light guide plate 12 can be seen.

As a result, since the camera 11 is visible, a crime deterrent effect can be obtained in the facility, etc.

FIG. 7 shows the state of the control device 20 in alert mode (second mode).

In alert mode, as a result of monitoring of the behavior of people within the capturing range of the camera 11 by the human behavior monitoring unit 22 of the control device 20 shown in FIG. 7, control is performed when it is determined that a suspicious person or the like is present.

At this point, the control device 20 puts the LED 13 in its lit state in which light is being emitted, and the light guide plate 12 displays, for example, a weather forecast pattern indicating sunny, cloudy, rainy, etc., as shown in FIG. 7.

When switching the pattern to be displayed on the light guide plate 12, for example, the LED 13 that irradiates the light guide plate 12 is switched to change the direction in which the light is incident on the light guide plate 12. As a result, light can be reflected in different patterns of the microprisms 12d to switch to a different design.

For example, when the human behavior monitoring unit 22 determines that a suspicious person is present, the light source control unit 26 controls the lighting of the LED 13 so that a specific pattern or the like is briefly displayed on the light guide plate 12.

Consequently, because a pattern or the like is briefly displayed on the light guide plate 12, which was substantially transparent in normal mode, the person P1 within the capturing range of the camera 11 can be induced to turn toward the light guide plate 12 as shown in FIG. 7.

Here, in a state where the LED 13 is lit and a pattern or the like is displayed on the light guide plate 12, the camera 11 on the rear surface side of the light guide plate 12 cannot be seen through the light guide plate 12. Therefore, since the light guide plate 12 is in an opaque state when viewed from a person in the capturing range, the camera 11 disposed adjacent to the rear surface (first surface 12b) side of the light guide plate 12 cannot be seen, which means that the person being photographed by the camera 11 will not feel uncomfortable.

On the other hand, because the microprisms 12d included in the light guide plate 12 are very small, a person who is in the capturing range can be photographed through the light guide plate 12 from the camera 11 disposed on the rear surface side of the light guide plate 12 on which the pattern, etc., is displayed.

In particular, in this embodiment, because patterns that attract people's interest are switched and displayed on the light guide plate 12, a person looking in the direction of the light guide plate 12 will be facing almost straight on toward the camera 11 disposed adjacent to the rear surface side of the light guide plate 12.

As a result, the camera 11 can easily acquire a facial image that can be used for facial recognition, and the accuracy of facial recognition can be improved.

Also, with the facial image acquisition system 10 of this embodiment, as discussed above, it is determined whether or not an image can be used for facial recognition, and the number of determinations is counted to carry out light control over the LED according to this count.

Consequently, because a pattern or the like is displayed on the light guide plate 12 in different lighting patterns until it is determined that a person who is within the capturing range of the camera 11 can be used for facial recognition, even if that person does not see the light guide plate 12 when the LED 13 is lit the first time, there is a greater likelihood that he or she will be able to see the light guide plate 12 when the LED 13 is turned on for the second time or when the LED 13 is turned on for the third time. Therefore, repeated attempts can be made by controlling the lighting of the LED 13 with different lighting patterns until a facial image determined to be usable for facial recognition can be acquired.

Also, even if the capturing range of the camera 11 is dark, the lighting of the LED 13 will make the light guide plate 12 shine brightly, and this brightness of the light guide plate 12 can be used to capture an image with the camera 11.

### Method for Controlling Facial Image Acquisition System 10

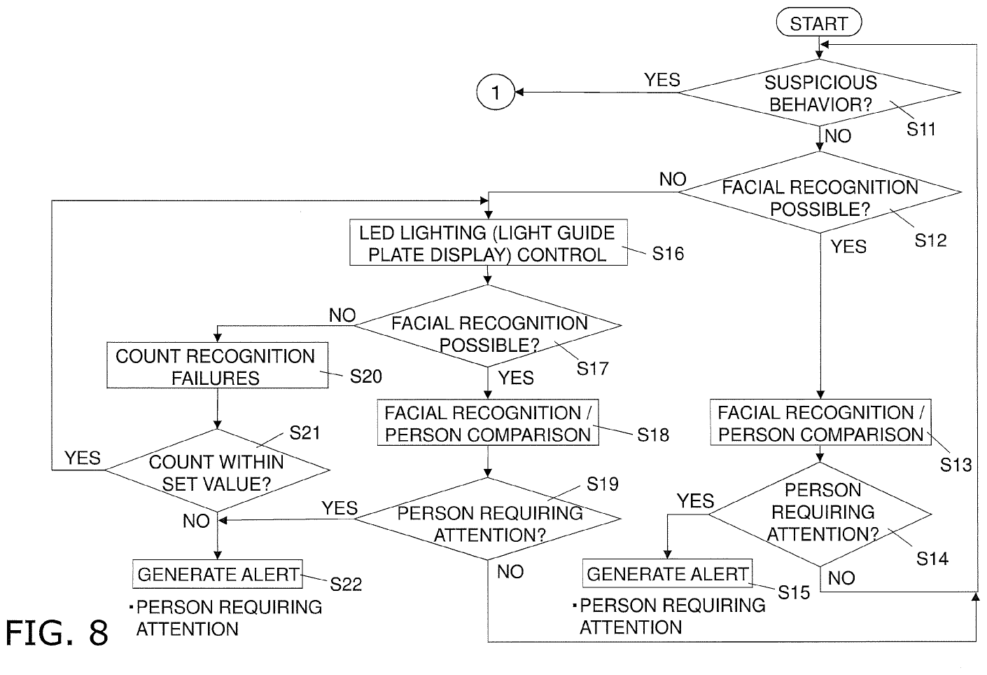

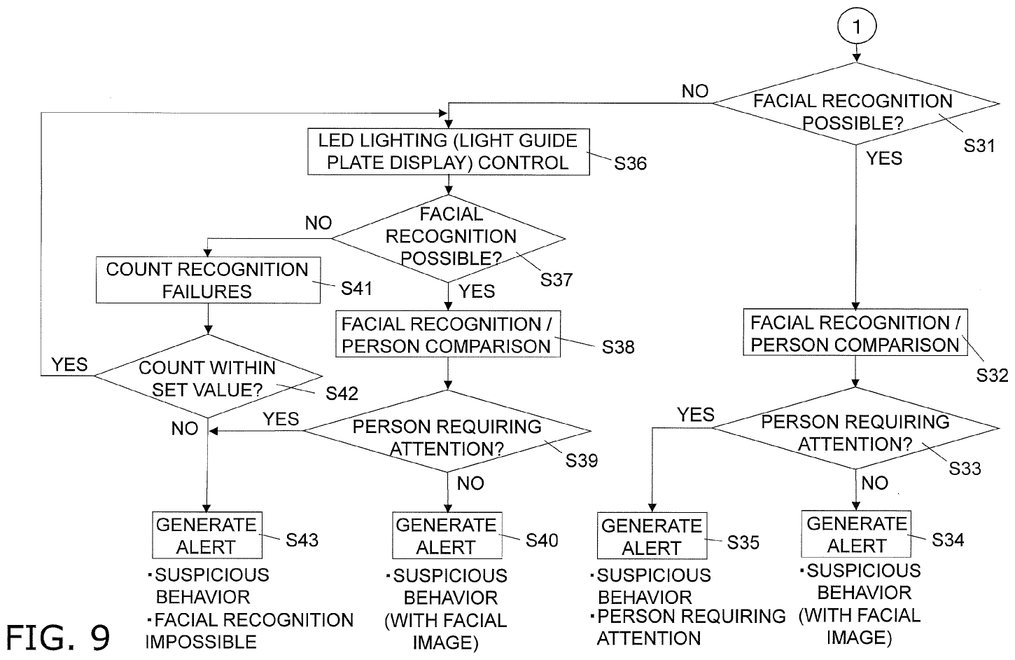

The facial image acquisition system 10 of this embodiment conducts a facial image acquisition system control method according to the flowcharts shown in FIGS. 8 and 9.

That is, as shown in FIG. 8, in step S11 the human behavior monitoring unit 22 of the control device 20 monitors whether or not any of the people in the capturing range of the camera 11 are acting suspiciously (image acquisition step). Here, if it is determined that there is a person acting suspiciously, the processing proceeds to the flow of FIG. 9, and if it is determined that there is no person acting suspiciously, the processing proceeds to step S12.

Next, in step S12 the facial recognition possibility determination unit 23 determines whether or not the image acquired from the camera 11 by the image acquisition unit 21 can be used for facial recognition. If it is determined that this image can be used for facial recognition, the processing proceeds to step S13. On the other hand, if it is determined that the image cannot be used for facial recognition, the processing proceeds to step S16.

Next, in step S13, since it was determined in step S12 that the acquired image can be used for facial recognition, the facial recognition unit 27 and the person comparison unit 28 carry out processing for facial recognition and person comparison.

Next, in step S14 the determination unit 29 determines whether or not the person whose face was recognized in step S13 matches a person requiring attention stored in the facial image database 31. Here, if there is a match, the processing proceeds to step S15. On the other hand, if the face does not match a person requiring attention, the processing goes back to step S11.

Next, in step S15, since it was determined in step S14 that there is a match with a person requiring attention, the alert generation unit 30 transmits an alert signal to the manager terminal 32, etc.

Next, in step S16, since it was determined in step S12 that the acquired image cannot be used for facial recognition, the light source control unit 26 controls the lighting of the LED 13 (display control over light guide plate 12) in order to acquire an image that is suited to facial recognition (display step).

Next, in step S17 the facial recognition possibility determination unit 23 determines whether or not the image acquired by the image acquisition unit 21 after lighting control of the LED 13 in step S16 can be used for facial recognition. If it is determined that this image can be used for facial recognition, the processing proceeds to step S18. On the other hand, if it is determined that the image cannot be used for facial recognition, the processing proceeds to step S20.

Next, in step S18, since it was determined in step S17 that the acquired image can be used for facial recognition, the facial recognition unit 27 and the person comparison unit 28 carry out facial recognition and person comparison processing.

Next, in step S19 the determination unit 29 determines whether or not the person whose face was recognized in step S18 matches a person requiring attention stored in the facial image database 31. Here, if there is a match, the processing proceeds to step S22. On the other hand, if it there is no match to a person requiring attention, the processing goes back to step S11.

In step S19 the person determined by the determination unit 29 not to be a person requiring attention is subjected to facial recognition and person comparison using an image suitable for facial recognition acquired as a result of the display on the light guide plate 12. Accordingly, with the facial image acquisition system 10 of this embodiment, a result indicating that a person is not someone requiring attention can be obtained with high accuracy.

Next, in step S20 the facial recognition failure counter 24 counts the number of times facial recognition was judged to be impossible in step S17.

Next, in step S21 the count determination unit 25 determines whether or not the count obtained by counting the number of times facial recognition was determined to be impossible in step S20 is less than a specific set value. If it is determined that the count is less than the specific set value, the processing goes back to step S16 to control the lighting of the LED 13 in a different lighting pattern.

Consequently, by controlling the lighting of the LED 13 in different lighting patterns until a facial image determined to be usable for facial recognition can be acquired, it is more likely that a facial image that can be used for facial recognition can be acquired.

On the other hand, if it is determined that the count is equal to or greater than the specific set value, the processing proceeds to step S22.

Next, in step S22, since it was determined in step S19 that there was a match with a person requiring attention, or it was determined in step S21 that the count value was equal to or greater than the set range, the alert generation unit 30 transmits an alert signal to the manager terminal 32, etc.

Next, the processing after the human behavior monitoring unit 22 has detected a person acting suspiciously in step S11 of FIG. 8 will be described with reference to FIG. 9.

That is, in step 531, since it was determined in step 511 of FIG. 8 that there is a person acting suspiciously, the facial recognition possibility determination unit 23 determines whether or not facial recognition is possible for the face image of the person determined to be suspicious. Here, if it is determined that this image can be used for facial recognition, the processing proceeds to step S32. On the other hand, if it is determined that the image cannot be used for facial recognition, the processing proceeds to step S36.

Next, in step S32, since it was determined in step S31 that the acquired image could be used for facial recognition, the facial recognition unit 27 and person comparison unit 28 carry out facial recognition and person comparison processing.

Next, in step S33 the determination unit 29 determines whether or not the person whose face was recognized in step S33 matches a person requiring attention stored in the facial image database 31. If there is a match, the processing proceeds to step S35. On the other hand, if there is no match to a person requiring attention, the processing proceeds to step S34.

Next, in step S34, although it was determined in step S33 that there was no match with a person requiring attention, the human behavior monitoring unit 22 has detected suspicious behavior of that person in step S11. Therefore, the alert generation unit 30 transmits an alert signal with an attached facial image as a suspicious behavior person to the manager terminal 32, etc.

The facial image transmitted to the manager terminal 32, etc., may be registered as a suspicious behavior person, for example, and added to the facial image database 31.

Next, in step S35, since it was determined in step S33 that there was a match with a person requiring attention, the alert generation unit 30 transmits an alert signal to the manager terminal 32, etc., under the assumption that the person registered as a person requiring attention is acting suspiciously.

Next, in step S36, since it was determined in step S31 that the acquired image can not be used for facial recognition, the light source control unit 26 performs lighting control over the LED 13 (display control over the light guide plate 12) (display step).

Next, in step S37 the facial recognition possibility determination unit 23 determines whether or not the image acquired by the image acquisition unit 21 after the lighting control of the LED 13 in step S36 can be used for facial recognition. If it is determined that this image can be used for facial recognition, the processing proceeds to step S38. On the other hand, if it is determined that the image cannot be used for facial recognition, the processing proceeds to step S41.

Next, in step S38, since it was determined in step S37 that the acquired image can be used for facial recognition, the facial recognition unit 27 and the person comparison unit 28 carry out facial recognition and person comparison processing.

Next, in step S39 the determination unit 29 determines whether or not the person whose face was recognized in step S38 matches a person requiring attention stored in the facial image database 31. Here, if there is a match, the processing proceeds to step S43. On the other hand, if there is no match with a person requiring attention, the processing proceeds to step S40.

Next, in step S40, although it was determined in step S39 that there is no match with a person requiring attention, the human behavior monitoring unit 22 has detected suspicious behavior of that person in step S11. Therefore, the alert generation unit 30 transmits an alert signal with an attached facial image as a suspicious behavior person to the manager terminal 32, etc.

The facial image transmitted to the manager terminal 32, etc., may be registered as a suspicious behavior person and added to the facial image database 31, for example.

In step S39 the person determined by the determination unit 29 not to be a person requiring attention is subjected to facial recognition and person comparison using an image suitable for facial recognition acquired as a suspicious behavior person as a result of the display on the light guide plate 12. Accordingly, with the facial image acquisition system 10 of this embodiment, a result indicating that a person who is not someone requiring attention is acting suspiciously can be obtained with high accuracy.

Next, in step S41, the facial recognition failure counter 24 counts the number of times that facial recognition was determined to be impossible in step S37.

Next, in step S42 the count determination unit 25 determines whether or not the count obtained by counting how many times that facial recognition was determined to be impossible in step S41 is less than a specific set value. Here, if it is determined that the count value is less than the specific set value, the processing goes back to step S36 to control the lighting of the LED 13 in a different lighting pattern.

On the other hand, if it is determined that the count is equal to or greater than the specific set value, the processing proceeds to step S43.

Next, in step S43, since it was determined in step S39 that there was a match with a person requiring attention, or it was determined in step S42 that the count value was equal to or greater than the set range, the alert generation unit 30 transmits an alert signal to the manager terminal 32, etc., on the assumption that facial recognition was impossible, but the person is acting suspiciously.

### Main Features

As shown in FIG. 2, the facial image acquisition system 10 of this embodiment comprises the camera 11, the light guide plate 12, the LED 13, and the control device 20. The camera 11 is installed in order to photograph people and captures images over a specific capturing range. The light guide plate 12 is provided at a position adjacent to the capturing side of the camera 11, internally reflects light incident from a specific direction and emits the light from a second surface on the opposite side from the first surface 12b facing the camera 11, performs the desired display, and is optically transmissive. The LED 13 irradiates the light guide plate from a specific direction. The control device 20 controls the LED 13 to emit light according to information obtained by the camera 11.

Consequently, by controlling the LED 13 and performing the desired display on the light guide plate 12 for a person who is in the capturing range of the camera, it is possible to catch the attention of a subject (such as a suspicious person, a person to be watched over, etc.) and induce that person to turn around in the direction of the light guide plate 12.

Therefore, the camera 11 disposed adjacent to the first surface 12b side of the light guide plate 12 can photograph the face of the subject substantially from the front, which means that an appropriate facial image for use in facial recognition or attribute discrimination can be acquired, for example.

Furthermore, it is difficult for a subject who is looking at the light guide plate 12 to see the camera 11 disposed adjacent to the rear surface (first surface) side of the light guide plate 12 in a state in which a specific display is being displayed on the light guide plate 12.

As a result, the accuracy of facial recognition and attribute discrimination of a person can be improved without making that person feel uncomfortable.

### Other Embodiments

An embodiment of the present invention was described above, but the present invention is not limited to or by the above embodiment, and various modifications are possible without departing from the gist of the invention.

### (A)

In the above embodiment, an example was given in which the present invention was realized as a facial image acquisition system and a method for controlling a facial image acquisition system. However, the present invention is not limited to this.

For example, the present invention may be realized as a control program that causes a computer to execute the above-mentioned method for controlling a facial image acquisition system.

This control program for a facial image acquisition system is stored in a memory (storage unit) installed in the facial image acquisition system, and the CPU reads the control program stored in the memory and causes the hardware to execute the various steps. More specifically, the same effect as described above can be obtained when the CPU reads a control program and executes the above-mentioned image acquisition step and display step.

Also, the present invention may be realized as a recording medium that stores a control program for a facial image acquisition system.

### (B)

In the above embodiment, as shown in FIG. 2, etc., an example was given in which the light guide plate 12 was disposed at a position adjacent to the capturing side of the camera 11, and the LED 13 irradiated the light guide plate 12 with light according to the information captured by the camera 11. However, the present invention is not limited to this.

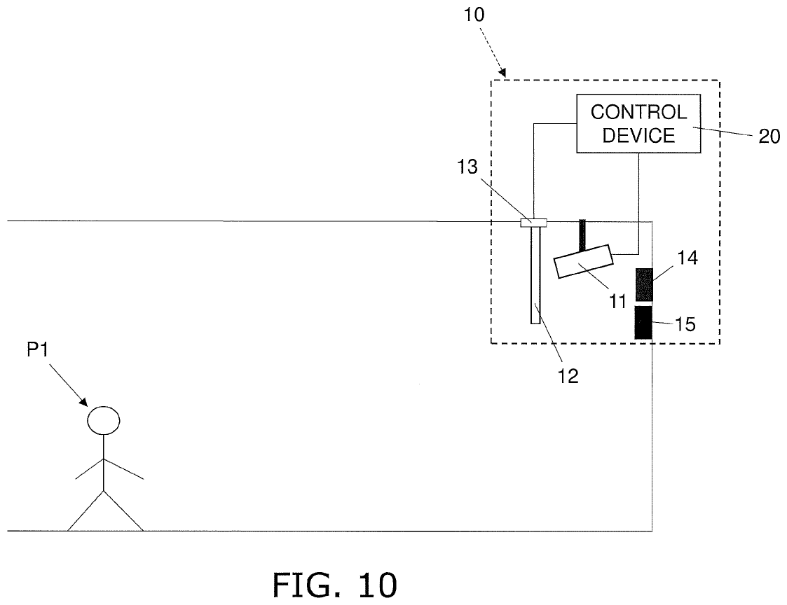

For example, as shown in FIG. 10, the facial image acquisition system may be configured such that a flash light (second light source) 14 and a speaker (sound information output unit) 15 are disposed on the rear surface (first surface) side of the light guide plate 12, near the camera 11.

In this case, in addition to the pattern, etc., displayed on the light guide plate 12, the flash light emitted from the flash light 14 can be used to attract the attention of a person who is in the capturing range of the camera 11, so that a facial image can be acquired in a state in which the subject is facing in the direction of the camera 11.

Also, in addition to the pattern, etc., displayed on the light guide plate 12, sound information emitted from the speaker 15 can be used to attract the attention of a person who is in the capturing range of the camera 11, so that a facial image can be acquired in a state in which the subject is facing in the direction of the camera 11.

That is, in addition to a display on the light guide plate 12, it is possible to use a combination of flash light from the flash light 14, sound from the speaker 15, or some other such means as the means for attracting the attention of a person who is in the capturing range.

### (C)

In the above embodiment, an example was given in which control was performed such that the camera 11 disposed adjacent to the rear surface side of the light guide plate 12 was made either visible or invisible from the capturing side by switching between whether there is or is not a display on the light guide plate 12 (whether the LED 13 was lit or unlit). However, the present invention is not limited to this.

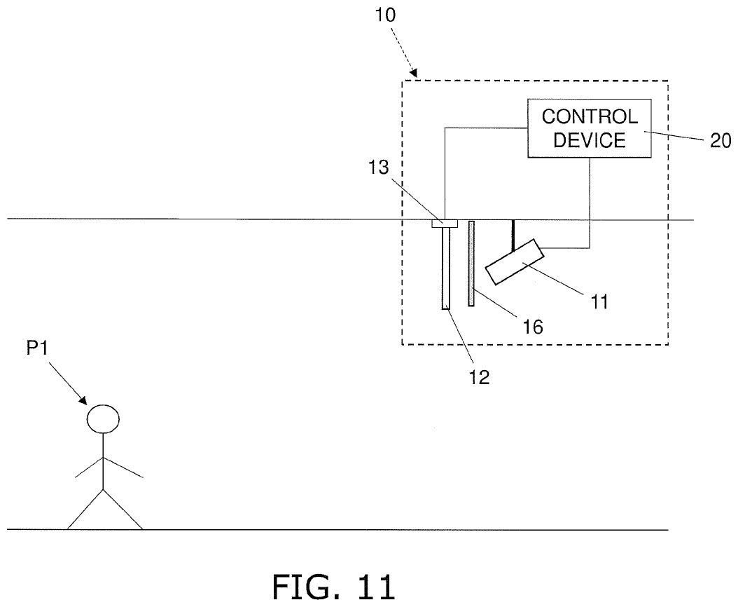

For example, as shown in FIG. 11, smoked panel 16 may be installed between the camera 11 and the light guide plate 12.

If this is done, the smoked panel 16 will make it difficult to see the camera 11 at all times, regardless of the presence or absence of a display on the light guide plate 12 (whether the LED 13 is lit or unlit).

Therefore, facial images of people who are in the capturing range of the camera 11 can be acquired without those people noticing the presence of the camera 11 and without feeling uncomfortable.

### (D)

In the above embodiment, an example was given in which the microprisms 12d were formed in a specific pattern on the inner surface side of the first surface 12b of the light guide plate 12, which was disposed opposite the camera 11. However, the present invention is not limited to this.

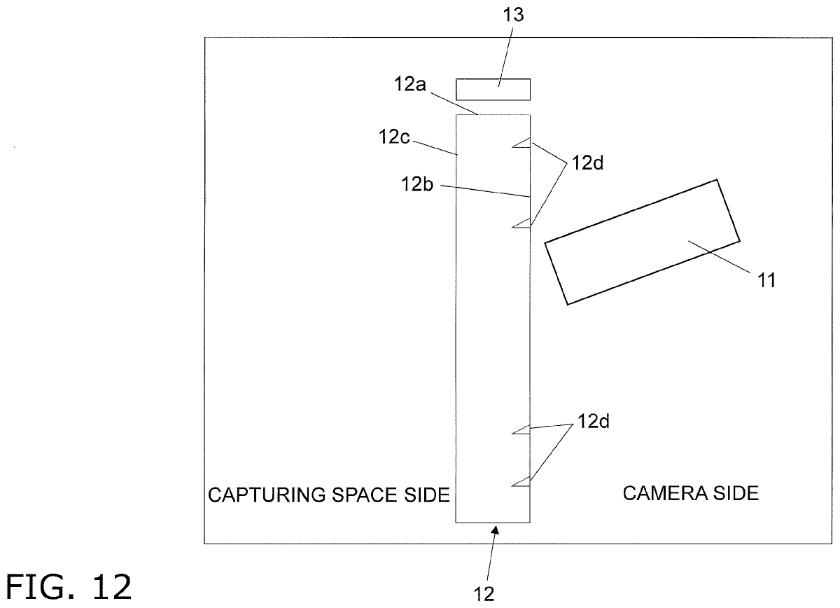

For example, as shown in FIG. 12, the configuration may comprise a light guide plate 12 having no microprisms 12d, at a position opposite the lens portion of the camera 11.

Therefore, the images captured by the camera 11 can be higher in definition, without being affected by the microprisms 12d.

### (E)

In the above embodiment, an example was given in which the light from the LED 13 was made incident on the light guide plate 12 disposed adjacent to the capturing side of the camera 11, and a pattern, etc., was displayed on the light guide plate 12, according to the image captured by the camera 11 installed on a wall, ceiling, etc., of a facility or the like. However, the present invention is not limited to this.

For example, the configuration may be such that a light guide plate is installed as a display near a particular product in a department store, etc., and a camera is installed on the rear surface side of the light guide plate.

In this case, an effective display of advertising or the like can be performed by switching the what is displayed on the light guide plate to suit the attributes of a person who is interested in that particular product and stops to look at it.

### (F)

In the above embodiment, an example was given in which the attention of people who were in the capturing range of the camera 11 was caught by using a pattern indicating a weather forecast (clear, cloudy, rain, etc.), which is of interest to a large number of people, as shown in FIG. 7, for the pattern displayed on the light guide plate 12. However, the present invention is not limited to this.

For example, the pattern displayed on the light guide plate is not limited to being a weather forecast, and may instead be an advertisement, a design, an image, or the like that tends to attract people's interest.

### (G)

In the above embodiment, an example was given in which, when light was incident on the light guide plate 12 from the LED 13, a pattern or the like was displayed on the light guide plate 12, thereby making the camera 11 disposed adjacent to the rear surface side of the light guide plate 12 invisible. However, the present invention is not limited to this.

For example, the configuration may be such that in a state in which a pattern or the like is displayed on the light guide plate, the camera is visible only to the extent that it cannot be determined whether or not it is a camera, rather than the camera being completely invisible.

### (H)

In the above embodiment, an example was given in which the control device 20 performed control to switch between a first mode, in which the LED 13 was switched off and no pattern or the like was displayed on the light guide plate 12, and a second mode, in which light was emitted from the LED 13 to display a pattern or the like on the light guide plate 12, according to the determination result of the human behavior monitoring unit 22. However, the present invention is not limited to this.

For example, control may be performed to switch between the first mode, in which the LED 13 is switched off and no pattern or the like is displayed on the light guide plate 12, and the second mode, in which light is emitted from the LED 13 to display a pattern or the like on the light guide plate 12, at regular time intervals, regardless of the behavior of a person in the capturing range of the camera.

Alternatively, control may be performed so as to switch between the first mode, in which the LED 13 is switched off and no pattern or the like is displayed on the light guide plate 12, and the second mode, in which light is emitted from the LED 13 to display a pattern or the like on the light guide plate 12, when the number of people in the capturing range of the camera is at or above a specific number.

### INDUSTRIAL APPLICABILITY

The facial image acquisition system of the present invention exhibits the effect of improving the accuracy of facial recognition and attribute discrimination of a person without making that person feel uncomfortable, and as such can be broadly applied to a facial image acquisition system featuring a camera installed in a train station, a shopping mall, a school, a senior facility, a hotel, an office building, or the like.

### REFERENCE SIGNS LIST

10 facial image acquisition system

11 camera

12 light guide plate

12a end surface (incident surface)

12b first surface

12c second surface (emission surface)

12d microprism

13 LED (first light source unit)

14 flash light (second light source unit)

15 speaker (sound information output unit)

16 smoked panel

20 control device (control unit)

21 image acquisition unit

22 human behavior monitoring unit

23 facial recognition possibility determination unit

24 facial recognition failure counter

25 count determination unit

26 light source control unit

27 facial recognition unit

28 person comparison unit

29 determination unit

30 alert generation unit (alert unit)

31 facial image database (storage unit)

32 manager terminal

33 terminal device

40 management information bus

P1 person

1. A facial image acquisition system, comprising:
a camera that is installed to photograph people, and configured to photograph within a specific capturing range;
a light guide plate that is provided at a position adjacent to a capturing side of the camera, that configured to internally reflect light incident from a specific direction and emit the light from a second surface on an opposite side from a first surface facing the camera, that configured to perform a desired display, and that is optically transmissive;
a first light source unit configured to cause light from the specific direction to be incident on the light guide plate; and
a control unit configured to control the first light source unit so as to emit light from the first light source unit according to information obtained by the camera.

2. The facial image acquisition system according to claim 1,
wherein, when the light emitted from the first light source unit is incident on the light guide plate, the light guide plate displays a pattern that attracts people's attention when viewed from the second surface.

3. The facial image acquisition system according to claim 1,
wherein, when the light emitted from the first light source unit is incident on the light guide plate, the light guide plate performs display such that the camera becomes invisible when viewed from the second surface.

4. The facial image acquisition system according to claim 1,
wherein the light guide plate makes the camera visible when viewed from the second surface in a state in which the light emitted from the first light source unit is not incident.

5. The facial image acquisition system according to claim 1,
further comprising a smoked plate that is provided between the light guide plate and the camera, and configured to make the camera invisible when viewed from a side of the second surface of the light guide plate.

6. The facial image acquisition system according to claim 1,
wherein the control unit has a first mode for switching off the first light source unit and a second mode for switching on the first light source unit.

7. The facial image acquisition system according to claim 6,
wherein, if an image obtained from the camera includes a person who seems to be a specific subject, the control unit irradiates the light guide plate with light from the first light source unit in the second mode.

8. The facial image acquisition system according to claim 1,
further comprising a human behavior monitoring unit configured to monitor a behavior of people within a capturing range of the camera and determine whether or not a person is a monitoring target.

9. The facial image acquisition system according to claim 1,
wherein the control unit controls the first light source unit so as to perform a specific display according to the attributes of a person looking in a direction of the camera.

10. The facial image acquisition system according to claim 9,
wherein the specific display includes advertisements and information of interest to the person.

11. The facial image acquisition system according to claim 1,
wherein the control unit controls an emission of light from the first light source unit by time division.

12. The facial image acquisition system according to claim 1,
further comprising a second light source unit that is disposed on a side of the first surface of the light guide plate and configured to emit a flash that causes a person to turn around.

13. The facial image acquisition system according to claim 1,
wherein a lens of the camera is disposed so as to be adjacent to an area provided on the first surface of the light guide plate and in which no light-reflecting microprisms are disposed.

14. The facial image acquisition system according to claim 1,
wherein the control unit performs control so as to switch a direction in which light is incident on the light guide plate, and switch a plurality of patterns displayed on the light guide plate.

15. The facial image acquisition system according to claim 14,
wherein microprisms corresponding to the plurality of patterns are disposed in a plurality of patterns inside the light guide plate, in a state in which a person's face can be recognized through the light guide plate from the camera.

16. The facial image acquisition system according to claim 1,
further comprising a sound information output unit configured to output sound information that matches what is displayed on the light guide plate.

17. The facial image acquisition system according to claim 1,
further comprising a facial recognition possibility determination unit configured to determine whether or not the facial recognition of a person photographed by the camera is at or above a specific determination value.

18. The facial image acquisition system according to claim 17,
wherein the control unit counts the number of times that a determination result from the facial recognition possibility determination unit is negative, and controls the first light source so that a display of the light guide plate is switched until the number of count exceeds a specific number of times.

19. The facial image acquisition system according to claim 18, further comprising:
a storage unit configured to store facial images of specific person in advance; and
a person comparison unit configured to compare the facial image of the person photographed by the camera with the facial images of the specific person stored in the storage unit when the determination result of the facial recognition possibility determination unit is at or above a count value by the control unit.

20. The facial image acquisition system according to claim 19,
further comprising an alert unit configured to issue an alert when it is determined that the facial image of the person photographed by the camera matches the facial image of a specific person stored in advance, as a result of comparison by the person comparison unit.

21. A method for controlling the facial image acquisition system according to claim 1, the method comprising:
an image acquisition step of acquiring an image of the specific capturing range photographed by the camera; and
a display step of performing a desired display as viewed from a side of the second surface of the light guide plate by emitting light from the first light source unit according to information about the image acquired in the image acquisition step.

22. A program for controlling a facial image acquisition system, which causes a computer to execute a method for controlling the facial image acquisition system according to claim 1, the method comprising:
an image acquisition step of acquiring an image of the specific capturing range photographed by the camera; and
a display step of performing a desired display as viewed from a side of the second surface of the light guide plate by emitting light from the first light source unit according to information about the image acquired in the image acquisition step.
